(19) United States
(12) Patent Application Publication
(10) Pub. No.: US 2012/0122753 A1
(43) Pub. Date: May 17, 2012

(54) LIQUID WASHING OR CLEANING AGENT COMPRISING ANTI-GRAYING POLYSACCHARIDE

(76) Inventors: Peter Schmiedel, Dusseldorf (DE); Ulrich Pegelow, Dusseldorf (DE); Evelyn Langen, Dusseldorf (DE); Sabine Schümann, Neuss (DE); Martina Hutmacher, Dusseldorf (DE); Heinz-Jürgen Völkel, Langenfeld (DE); Marc-Steffen Schiedel, Dusseldorf (DE); Matthias Sunder, Dusseldorf (DE); Birgit Glüsen, Dusseldorf (DE); Cornelius Bessler, Dusseldorf (DE); Timothy O'Connell, Dusseldorf (DE)

(21) Appl. No.: 13/349,672

(22) Filed: Jan. 13, 2012

Related U.S. Application Data
(63) Continuation of application No. PCT/EP2010/060242, filed on Jul. 15, 2010.

(30) Foreign Application Priority Data
Jul. 17, 2009 (DE) 10 2009 027 811.7

(51) Int. Cl. C11D 17/00

(52) U.S. Cl. 510/325

(57) ABSTRACT

The present invention relates to a stable liquid washing or liquid cleaning agent comprising an anti-graying polysaccharide. The invention further relates to the use of the liquid washing or liquid cleaning agent and to a method for the production thereof.

### CROSS-REFERENCE TO RELATED APPLICATIONS

This application is a continuation of PCT Application Ser. No. PCT/EP2010/060242, filed on Jul. 15, 2010, which claims priority under 35 U.S.C. §119 to 10 2009 027 811.7 (DE), filed on Jul. 17, 2009. The disclosures PCT/EP2010/060242 and DE 10 2009 027 811.7 are hereby incorporated by reference in their entirety.

### FIELD OF THE INVENTION

The present invention relates to a liquid washing or cleaning agent comprising at least one surfactant and a graying-inhibiting polysaccharide. The invention also relates to the use of the washing or cleaning agent as well as a process for its manufacture.

### BACKGROUND OF THE INVENTION

In order to increase the washing or cleaning performance of washing or cleaning agents, one or more additives are often included. For example, in order to prevent a redeposition of finely dispersed, previously released dirt, washing agents preferably comprise so-called graying inhibitors, such as carboxymethyl cellulose (CMC).

EP 054325 A1 describes a washing agent with carboxymethyl cellulose as the graying inhibitor.

However, due to the low solubility of carboxymethyl cellulose in liquid washing or cleaning agent compositions, liquid washing or cleaning agents comprising carboxymethyl cellulose as the graying inhibitor have not yet appeared in the market. Another technical issue is that stable dispersions of the carboxymethyl cellulose in the matrix of a washing or cleaning agent are very difficult to obtain, and precipitations in the form of sediments and/or residues occur during storage of a carboxymethyl cellulose-containing washing or cleaning agent.

Carboxymethyl cellulose can be incorporated into powdered washing agents without problem, and there is a significantly lower graying of the washing compared to liquid washing agents.

With these technical issues in mind, there is clearly an unmet need for stable liquid washing or cleaning agent comprising a polysaccharide as the graying inhibitor.

### SUMMARY OF THE INVENTION

It has now been surprisingly found that graying-inhibiting polysaccharides can be stably incorporated into liquid washing or cleaning agents if the liquid matrix comprises both a thickener and an inorganic salt.

In an exemplary embodiment of the present invention, a stable, liquid washing or cleaning agent comprises 0.1 to 60 wt % surfactant, 0.1 to 5 wt % of a graying-inhibiting polysaccharide, 0.05 to 1 wt % of a thickener, and 1 to 20 wt % of an inorganic salt.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

With that said, the present invention is a liquid washing or cleaning agent composition that comprises a graying-inhibiting polysaccharide such as CMC, made stable by the presence of both a thickener and an inorganic salt in the liquid matrix. In general, the present invention is a stable liquid washing or cleaning agent comprising: (a) 0.1 to 60 wt % surfactant; (b) 0.1 to 5 wt % of a graying-inhibiting polysaccharide; (c) 0.05 to 1 wt % of a thickener; and (d) 1 to 20 wt % of an inorganic salt.

The addition of the salt is believed to provoke a micro phase separation in the liquid washing or cleaning agent, subsequently resulting in a surfactant-rich phase dispersed in a continuous, surfactant-poor phase. The presence of the thickener is believed to prevent the continuous, surfactant-poor phase from macroscopically separating out. In addition, due to the combination with the inorganic salt, relatively low amounts of thickener suffice to increase viscosity and stably disperse solids in the liquid matrix.

It is advantageous if the graying-inhibiting polysaccharide is selected from the group consisting of carboxymethyl cellulose (CMC), ether sulfonic acid salts of starch, ether sulfonic acid salts of cellulose, acidic sulfuric acid ester salts of cellulose, acidic sulfuric acid ester salts of starch, methyl cellulose, ethyl cellulose, hydroxyethyl cellulose, hydroxypropyl cellulose methyl hydroxyethyl cellulose, methyl carboxymethyl cellulose, ethyl hydroxyethyl cellulose, and mixtures thereof. The polysaccharide carboxymethyl cellulose, in particular sodium carboxymethyl cellulose, is quite particularly preferred.

These preferred graying-inhibiting polysaccharides afford a particularly good anti-graying effect to the washing or cleaning agents.

It is preferred if the inorganic salt is selected from the group consisting of sodium chloride, potassium chloride, sodium sulfate, sodium carbonate, potassium sulfate, potassium carbonate, sodium hydrogen carbonate, potassium hydrogen carbonate, calcium chloride, magnesium chloride, and mixtures thereof, because these salts are highly water-soluble.

It is further preferred that the thickener is selected from the group consisting of xanthan, guar, carrageenan, agar agar, gellan, pectin, locust bean flour, and mixtures thereof. These compounds are also effective thickeners in the presence of inorganic salts. In a particularly preferred embodiment, the washing or cleaning agent comprises xanthan as the thickener, as xanthan thickens effectively even in the presence of high salt concentrations and prevents a macroscopic separation of the continuous phase.

In a particularly preferred embodiment, the washing or cleaning agent further includes a cellulase.

The formulation of cellulose (and/or its derivatives) and cellulase together in a liquid product usually leads to a degradation of the cellulose (derivatives) by the cellulase over time, such as during storage. In the present invention, graying-inhibiting cellulose (and/or its derivatives), such as CMC, can be incorporated in not only a physically stable manner but also in a chemically stable manner. Without wishing to be bound by any theory, the graying-inhibiting polysaccharide and the cellulase seem to be present in different phases, and are therefore physically separated from one another. In this regard, the cellulose is present in the surfactant-rich phase and the cellulase is in the continuous surfactant-poor phase.

In a preferred embodiment, the liquid washing or cleaning agent comprises an acrylic polymer. It has been surprisingly found that the graying-inhibiting action of the liquid washing or cleaning agent can be enhanced by the presence of an acrylic polymer.

The present invention also relates to the use of the inventive washing or cleaning agent for washing and/or cleaning textile fabrics.

The invention also includes the use of 0.05 to 1 wt % of a thickener and 1 to 20 wt % of an inorganic salt for producing a micro phase separation in a liquid washing or cleaning agent. The liquid washing or cleaning agent preferably comprises a graying-inhibiting polysaccharide.

In another aspect, the invention relates to a process for manufacturing a micro two-phase liquid washing or cleaning agent comprising 0.1 to 60 wt % surfactant, 0.1 to 5 wt % of a graying-inhibiting polysaccharide, and 0.05 to 1 wt % of a thickener, with said method comprising the step of (a) adding from 1 to 20 wt % of an inorganic salt to the liquid washing or cleaning agent.

The invention is described below in more detail inter alia by way of exemplary embodiments.

The liquid washing or cleaning agent according to the invention comprises a graying-inhibiting polysaccharide, surfactant, a thickener and an inorganic salt.

The liquid washing or cleaning agent preferably comprises carboxymethyl cellulose (CMC), an ether sulfonic acid salt of starch, an ether sulfonic acid salt of cellulose, an acidic sulfuric acid ester salt of cellulose, an acidic sulfuric acid ester salt of starch, methyl cellulose, ethyl cellulose, hydroxyethyl cellulose, hydroxypropyl cellulose methyl hydroxyethyl cellulose, methyl carboxymethyl cellulose, ethyl hydroxyethyl cellulose, or a mixture of these graying-inhibiting polysaccharides as the graying-inhibiting polysaccharide. The graying-inhibiting polysaccharide carboxymethyl cellulose, in particular sodium carboxymethyl cellulose, is quite particularly preferred.

The amount of graying-inhibiting polysaccharide is preferably from 0.1 to 5 wt %, based on the total weight of the washing or cleaning agent. The amount of graying-inhibiting polysaccharide is preferably 0.2 to 4 wt %, and quite particularly preferably between 0.5 and 3 wt %, based on the total amount of the washing or cleaning agent.

Sodium carboxymethyl celluloses are preferably incorporated in powder form and/or in granulate form with a bulk density of 300 to 700 g/L and a substitution degree of 0.4 to 1.5, preferably 0.5 to 0.9. The substitution degree indicates how many of the three possible hydroxyl groups of the cellulose are etherified.

In addition to the graying-inhibiting polysaccharide, the washing or cleaning agent comprises at least one surfactant, wherein anionic, non-ionic, zwitterionic and/or amphoteric surfactants can be employed. Mixtures of anionic and non-ionic surfactants are preferred. The total surfactant content of the liquid washing or cleaning agent is preferably below 60 wt % and particularly preferably below 45 wt %, based on the total weight of the liquid washing or cleaning agent.

Suitable non-ionic surfactants include alkoxylated fatty alcohols, alkoxylated fatty acid alkyl esters, fatty acid amides, alkoxylated fatty acid amides, polyhydroxyfatty acid amides, alkylphenol polyglycol ethers, amine oxides, alkyl polyglucosides and mixtures thereof.

Preferred non-ionic surfactants include the alkoxylated, and preferably ethoxylated, primary alcohols containing 8 to 18 carbon atoms and, on average, 1 to 12 moles of ethylene oxide (EO) per mole of alcohol, in which the alcohol group may be linear or, preferably, methyl-branched in the 2-position, or may contain e.g. linear and methyl-branched groups in the form of the mixtures typically present in Oxo alcohol groups. In particular, however, alcohol ethoxylates with linear alcohol groups of natural origin having 12 to 18 carbon atoms, e.g. available from coco-, palm-, tallow- or oleyl alcohol, and an average of 2 to 8 EO per mole alcohol are preferred. Exemplary preferred ethoxylated alcohols include C₁₂₋₁₄ alcohols with 3 EO, 4 EO or 7 EO, C₉₋₁₁ alcohol with 7 EO, C₁₃₋₁₅ alcohols with 3 EO, 5 EO, 7 EO or 8 EO, C₁₂₋₁₈ alcohols with 3 EO, 5 EO or 7E0 and mixtures thereof, such as mixtures of C₁₂₋₁₄ alcohol with 3 EO and C₁₂₋₁₈ alcohol with 7 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO. Also, non-ionic surfactants that comprise the EO and PO groups together in the molecule are employable according to the invention. Further suitable is also a mixture of a (highly) branched ethoxylated fatty alcohol and a linear ethoxylated fatty alcohol, such as for example a mixture of a C₁₆₋₁₈ fatty alcohol with 7 EO and 2-propylheptanol with 7 EO. The washing, cleaning, post-treatment or auxiliary washing agent particularly preferably comprises a C₁₂₋₁₈ fatty alcohol with 7 EO or a C₁₃₋₁₅ oxoalcohol with 7 EO.

The content of non-ionic surfactants in the washing or cleaning agent is preferably from 3 to 40 wt %, advantageously 5 to 30 wt %, and particularly from 7 to 20 wt %, in each case based on the total weight of the washing or cleaning agent.

In addition to the non-ionic surfactants, the washing or cleaning agent may also comprise anionic surfactants. Sulfonates, sulfates, soaps, alkyl phosphates, anionic silico-surfactants, and mixtures thereof are preferably employed as the anionic surfactant.

Suitable surfactants of the sulfonate type are, advantageously C₉₋₁₃ alkylbenzene sulfonates, olefin sulfonates, i.e. mixtures of alkene- and hydroxyalkane sulfonates and disulfonates, as are obtained, for example, from C₁₂₋₁₈ monoolefins having a terminal or internal double bond, by sulfonation with gaseous sulfur trioxide and subsequent alkaline or acidic hydrolysis of the sulfonation products. C₁₂₋₁₈ Alkane sulfonates and the esters of α-sulfofatty acids (ester sulfonates), for example the α-sulfonated methyl esters of hydrogenated coco-, palm nut- or tallow acids, are also suitable.

Preferred alk(en)yl sulfates are the alkali metal and especially the sodium salts of the sulfuric acid half-esters derived from the C₁₂-C₁₈ fatty alcohols, for example from coconut butter alcohol, tallow alcohol, lauryl, myristyl, cetyl or stearyl alcohol or from C₁₀-C₂₀ Oxo alcohols and those half-esters of secondary alcohols of these chain lengths. The C₁₂-C₁₆ alkyl sulfates and C₁₂-C₁₅ alkyl sulfates as well as C₁₄-C₁₅ alkyl sulfates are preferred on the grounds of washing performance. 2,3-Alkyl sulfates are also suitable anionic surfactants.

Sulfuric acid mono-esters derived from straight-chain or branched C₇₋₂₁ alcohols ethoxylated with 1 to 6 moles ethylene oxide are also suitable, for example 2-methyl-branched C₉₋₁₁ alcohols with an average of 3.5 mole ethylene oxide (EO) or C₁₂₋₁₈ fatty alcohols with 1 to 4 EO.

Soaps are also preferred anionic surfactants. Saturated and unsaturated fatty acid soaps are suitable, such as the salts of lauric acid, myristic acid, palmitic acid, stearic acid, (hydrogenated) erucic acid and behenic acid, and especially soap mixtures derived from natural fatty acids such as coconut oil fatty acid, palm kernel oil fatty acid, olive oil fatty acid or tallow fatty acid.

The anionic surfactants, including the soaps, can be present in the form of their sodium, potassium, magnesium, or ammonium salts. The anionic surfactants are preferably present in the form of their sodium salts. Other preferred counter ions for the anionic surfactants include the protonated forms of amines such as choline, triethylamine or methylethylamine.

The content of anionic surfactants in a washing or cleaning agent is preferably from 1 to 40 wt %, advantageously from 5 to 30 wt %, and quite particularly preferably from 10 to 25 wt %, in each case based on the total weight of washing or cleaning agent.

The washing or cleaning agent further comprises a thickener as an essential ingredient of the composition. The thickener may comprise for example xanthan, guar, carrageenan, agar agar, gellan, pectin, locust bean flour, and mixtures thereof. In combination with the inorganic salt, these thickeners lend the washing or cleaning agent a flow limit even at low temperatures. Xanthan is particularly preferably employed as the thickener, as it also stably and effectively thickens the washing or cleaning agent at high salt concentrations. In addition, the thickener stabilizes the continuous surfactant-poor phase and prevents a macroscopic phase separation.

Alternatively, (meth)acrylic acid copolymers can also be employed as the thickener. Suitable acrylic and methacrylic copolymers include, but are not limited to, the high molecular weight homopolymers of acrylic acid, optionally crosslinked with a polyalkenyl polyether, in particular an allyl ether of saccharose, pentaerythritol or propylene (INCI name according to the “International Dictionary of Cosmetic Ingredients” of “The Cosmetic, Toiletry and Fragrance Association (CTFA)”: Carbomer), which are also called carboxyvinyl polymers. Polyacrylic acids of this type are available inter alia under the trade names Polygel® and Carbopol®. For example, the following acrylic acid copolymers are also suitable: (i) copolymers of two or more monomers of the group of the acrylic acid, methacrylic acid and their simple esters, preferably formed with C₁₋₄ alkanols (INCI Acrylates Copolymer), which are available for example under the trade names Aculyn®, Acusol® or Tego® Polymer; (ii) crosslinked high molecular weight acrylic acid copolymers, to which belong for example the copolymers of C₁₀₋₃₀ alkyl acrylates with one or more monomers of the group of the acrylic acid, methacrylic acid and their simple esters, preferably formed with C₁₋₄ alkanols, crosslinked with an allyl ether of saccharose or of pentaerythritol (INCI Acrylates/C₁₀₋₃₀ Alkyl Acrylate Crosspolymer) and which are available under the trade name Carbopol®. Further suitable polymers are (meth)acrylic acid (co)polymers of the Sokalan® type.

It may be preferred that the inventive washing or cleaning agent comprises a (meth)acrylic acid (co)polymer in combination with another thickener, preferably xanthan.

The washing or cleaning agent may comprise 0.05 to 1.5 wt % and preferably 0.1 to 1 wt % thickener, each based on the total washing or cleaning agent. The amount of thickener depends on the type of thickener and the desired degree of thickening.

Another essential ingredient of the inventive washing or cleaning agent is the inorganic salt. Depending on the surfactant system employed, the salt is added in an amount of from 1 to 20 wt %, based on the total weight of washing or cleaning agent.

Preferred inorganic salts include sodium chloride, potassium chloride, sodium sulfate, sodium carbonate, potassium sulfate, potassium carbonate, sodium hydrogen carbonate, potassium hydrogen carbonate, calcium chloride, magnesium chloride and mixtures thereof. Particularly stable washing or cleaning agents are obtained by adding sodium sulfate.

The addition of the inorganic salt leads to a separation of the liquid matrix of the washing or cleaning agent composition into a surfactant-rich, liquid crystalline phase dispersed in a continuous, surfactant-poor phase. This micro phase separation makes it possible to stably disperse a graying-inhibiting polysaccharide in a liquid washing or cleaning agent.

The inorganic salt additionally has an influence on the viscosity of the washing or cleaning agent of the present invention, and this viscosity can be adjusted with the amount of inorganic salt in such a way that the washing or cleaning agent doses well and such that a container with the washing or cleaning agent is easily emptied.

In addition to the graying-inhibiting polysaccharide, the surfactant(s), the thickener, and the inorganic salt, the washing or cleaning agent may also comprise additional ingredients that further improve the applied uses and/or the esthetic properties of the washing or cleaning agent. In the context of the present invention, the washing or cleaning agent may additionally comprise at least one of substances selected from the group consisting of builders, bleaching agents, enzymes, electrolytes, non-aqueous solvents, pH adjustors, perfumes, perfume carriers, fluorescent agents, dyes, hydrotropes, foam inhibitors, silicone oils, soil-release polymers, additional graying inhibitors, shrink preventers, anti-crease agents, color transfer inhibitors, antimicrobials, germicides, fungicides, antioxidants, preservatives, corrosion inhibitors, antistats, bittering agents, ironing aids, water-repellents and impregnation agents, swelling and non-skid agents, softening components, UV-absorbers, and mixtures thereof.

Silicates, aluminum silicates (particularly zeolites), carbonates, salts of organic di- and polycarboxylic acids as well as mixtures of these materials are useful as builders in the washing or cleaning agent.

Exemplary organic builders include, but are not limited to, the polycarboxylic acids usable in the form of their sodium salts, where polycarboxylic acids are understood to be carboxylic acids that carry more than one acid functional group. These include, for example, citric acid, adipic acid, succinic acid, glutaric acid, malic acid, tartaric acid, maleic acid, fumaric acid, sugar acids, amino carboxylic acids, nitrilotriacetic acid (NTA), methylglycine diacetic acid (MGDA) and their derivatives, and mixtures thereof. Preferred salts are the salts of polycarboxylic acids such as citric acid, adipic acid, succinic acid, glutaric acid, tartaric acid, sugar acids and mixtures thereof.

Polymeric polycarboxylates are also suitable as builders. They are for example the alkali metal salts of polyacrylic or polymethacrylic acid, for example those with a molecular weight of from about 600 to 750,000 g/mol.

Particularly suitable polymers include the polyacrylates having a molecular weight of from about 1,000 to 15,000 g/mol. By virtue of their superior solubility, preferred representatives from this group are the short-chain polyacrylates with molecular weights of 1,000 to 10,000 g/mol, and more preferably from about 1,000 to 5,000 g/mol.

Further suitable copolymeric polycarboxylates include the copolymers having acrylic acid and methacrylic acid monomers, and having acrylic acid or methacrylic acid and maleic acid monomers. In order to improve the water solubility, the polymers can also comprise allyl sulfonic acids, allyloxybenzene sulfonic acid and methallyl sulfonic acid monomers.

However, soluble builders are preferred, such as for example citric acid, or acrylic polymers having a molecular weight of 1,000 to 5,000 g/mol.

The washing or cleaning agent preferably includes an acrylic polymer to further increase the graying-inhibiting action of the washing or cleaning agent. In the context of this invention, the term acrylic polymer is understood to mean (co)polymers that contain at least one monomer selected from the group consisting of acrylic acid, methacrylic acid, acrylic acid esters or methacrylic acid esters. The acrylic polymer can be a thickening acrylic polymer and may be employed in the washing or cleaning agent as a thickener. In this case the acrylic polymer is likely hydrophobically modified. Alternatively, the acrylic polymer can also function as a builder. A particularly strong increase in the graying-inhibiting action is observed with (poly)anionic acrylic polymers. For this reason the washing or cleaning agent includes a homopolymer of acrylic acid as the preferred acrylic polymer.

The liquid washing or cleaning agent can also comprise an enzyme or a mixture of enzymes. Suitable enzymes are, in particular, those from the classes of hydrolases, such as the proteases, (poly)esterases, lipases amylases, glycosyl hydrolases, hemicellulases, cutinases, β-glucanases, oxidases, peroxidases, mannanases, perhydrolases, oxidoreductases, laccases, and mixtures thereof.

In particular, it is possible to incorporate cellulases into the washing or cleaning agent without these significantly degrading the graying-inhibiting polysaccharide.

In the context of the present invention, cellulases are preferably added in combination with proteases, amylases, lipases, mannanases, laccases, tannanases and esterases/polyesterases as well as with mixtures of two or more of these enzymes.

The quantity of enzyme(s) is from 0.01 to 10 wt %, and preferably from 0.12 to about 3 wt %, based on the total weight of the composition. The enzymes are preferably added as enzyme-liquid formulation(s). If the liquid washing or cleaning agent comprises a mixture of enzymes, then at least one enzyme can be granulate, encapsulated, or adsorbed on a carrier. Quite preferred washing or cleaning agents comprise cellulase; cellulase and protease; cellulase, protease and amylase; cellulase, protease, amylase and lipase or amylase; cellulase, protease, amylase, lipase and mannanase.

The washing or cleaning agents according to the invention are liquid and comprise water as the major solvent. In addition, non-aqueous solvents can be added to the washing or cleaning agent. Suitable non-aqueous solvents include mono- or polyhydric alcohols, alkanolamines or glycol ethers, in so far that they are miscible with water in the defined concentration range. The solvent is preferably selected from the group consisting of ethanol, n-propanol, i-propanol, butanols, glycol, propane diol, butane diol, glycerin, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, di-isopropylene glycol monomethyl ether, di-isopropylene glycol monoethyl ether, methoxytriglycol, ethoxytriglycol, butoxytriglycol, 1-butoxyethoxy-2-propanol, 3-methyl-3-methoxybutanol, propylene glycol t-butyl ether, di-n-octyl ether, and mixtures thereof. It is preferred that the washing or cleaning agent comprises a polyol as the non-aqueous solvent. In particular, the polyol may be glycerin, 1,2-propane diol, 1,3-propane diol, ethylene glycol, diethylene glycol, dipropylene glycol, or mixtures thereof. The washing or cleaning agent preferably comprises a mixture of a polyol and a monohydric alcohol.

Non-aqueous solvents can be added to the washing or cleaning agent in amounts between 0.5 and 15 wt %. However it is preferable that the non-aqueous solvent, if present, be below about 12 wt % based on the total weight of the composition.

The washing or cleaning agents according to the invention can be used for washing and/or cleaning textile fabrics.

The washing or cleaning agents are manufactured by means of usual and known methods and processes. For example, the ingredients may be blended in a stirred tank with the water preferably added first. The thickener and subsequently the inorganic salt are then added to the stirred water followed by the surfactant(s) and any non-aqueous solvents (if used). The fatty acid, when present, is then added, and alkalinity present results in the saponification of the fatty acid(s) as well as any anionic surfactants that were added in their acid form. The further ingredients, including the graying-inhibiting polysaccharide, are then added, preferably in portions.

TABLE 1 shows one exemplary embodiment of the inventive washing or cleaning agent, designated E1. All quantities in TABLE 1 represent weight percent (wt %) active substances, where the weight of the ingredient is based on the total weight of the composition.

TABLE 1
Exemplary Composition with Anti-Graying Polysaccharide

| Ingredients (in wt. % actives) | E1 |
|---|---|
| Linear C10-C13 alkylbenzene sulfonic acid, Na salt | 21.4 |
| C12-14 fatty alcohol/7 EO | 10 |
| Xanthan | 0.1 |
| Polyacrylic acid (MW = ~4.500) | 1 |
| Citric acid, Na salt | 2.5 |
| Phosphonic acid, Na salt | 0.8 |
| Boric acid, Na salt | 1.06 |
| Carboxymethyl cellulose, Na salt | 1.4 |
| Optical brightener | 0.08 |
| 1,2-Propane diol | 5 |
| Ethanol | 3.5 |
| Silicone defoamer | 0.05 |
| Cellulase | 0.1 |
| Additional enzymes (amylase & protease) | 2 |
| Sodium sulfate | 5 |
| Perfume | 1.5 |
| Colorant | + |
| Water | q.s. |
| Total | 100 |

The sodium carboxymethyl cellulose used for the exemplary composition E1 of TABLE 1 had a bulk density of 300 to 600 g/L and a substitution degree of 0.8±0.05.

The resulting composition E1 was stable for weeks in storage.

A washing test was conducted to demonstrate the graying-inhibiting action. For this, the washing or cleaning agent E1 was compared to a commercial powdered washing agent (V1) (with a sodium carboxymethyl cellulose content of 1.4 wt %) and to a commercial liquid washing agent V2 that did not contain any graying-inhibiting polysaccharide.

For the test, a domestic washing machine (Miele W 526) was loaded with 3.5 kg of lightly soiled, white laundry consisting of various materials (cotton, polyester, polyamide, mixed wovens, etc.). Five consecutive washes were carried out at 40° C. (dosing: liquid=95 mL and solid=195 mL). The laundry was hung to dry and brightness values (Y-value of the tristimulus values {X, Y, Z}) determined spectrophotometrically. The performance results are shown in TABLE 2.

TABLE 2
BRIGHTNESS VALUES (Y-Value)

| | Test Product | | |
|---|---|---|---|
| TEXTILE TYPE | E1 | V1 | V2 |
| Cotton | 83.1 | 81.3 | 79.9 |
| Polyester | 79 | 76.2 | 77.2 |
| Average value for all textiles | 83 | 80.9 | 80.5 |

The values in TABLE 2 clearly show that the laundry treated with the inventive washing or cleaning agent E1 exhibits noticeably higher y-values and has consequently become less strongly gray than the washing that was treated with the comparative formulations V1 and V2.

From these results, it is clear that the inventive washing or cleaning agent even exhibits a markedly stronger graying-inhibiting action than the powdered washing agent.

In order to demonstrate that a favorable flow behavior of the washing or cleaning agent can be reached with the aid of the inorganic salt, the salt concentration was varied, each in compensation for water, for a washing or cleaning agent having a composition according to TABLE 1, and the viscosities of the resulting washing or cleaning agent were determined. Viscosity was measured with a Brookfield viscometer at a temperature of 20° C. and a rotation of 20 rpm. Spindle 3 was used for the salt concentrations of 0 wt %, 2 wt % and 5 wt % whereas spindle 4 was used for the other concentrations. The results are delineated in TABLE 3.

TABLE 3
VISCOSITY VERSUS SALT CONTENT

| Salt content [wt %] | 0 | 2 | 5 | 7 | 10 |
|---|---|---|---|---|---|
| Viscosity [mPas] | 5,630 | 3,955 | 4,335 | 7,270 | 16,750 |

The reference composition in TABLE 3 having no salt content (0 wt %) is not part of the present invention as this composition is not micro two-phase in nature without added inorganic salt.

The values in TABLE 3 clearly show that the salt concentrations exercise a significant influence on the viscosity of the washing or cleaning agent. An advantageous/desired flow behavior can be set by means of the salt concentration.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. A liquid washing or cleaning agent comprising:
a. from 0.1 to 60 wt. % surfactant;
b. from 0.1 to 5 wt. % of a graying-inhibiting polysaccharide;
c. from 0.05 to 1 wt. % of a thickener; and
d. from 1 to 20 wt. % of an inorganic salt.

2. The liquid washing or cleaning agent of claim 1, wherein said graying-inhibiting polysaccharide is selected from the group consisting of carboxymethyl cellulose, ether sulfonic acid salts of starch, ether sulfonic acid salts of cellulose, acidic sulfuric acid ester salts of cellulose, acidic sulfuric acid ester salts of starch, methyl cellulose, ethyl cellulose, hydroxyethyl cellulose, hydroxypropyl cellulose, methyl hydroxyethyl cellulose, methyl carboxymethyl cellulose, ethyl hydroxyethyl cellulose, and mixtures thereof.

3. The liquid washing or cleaning agent of claim 2, wherein said polysaccharide is carboxymethyl cellulose.

4. The liquid washing or cleaning agent of claim 2, wherein said polysaccharide is sodium carboxymethyl cellulose.

5. The liquid washing or cleaning agent of claim 1, wherein said inorganic salt is selected from the group consisting of sodium chloride, potassium chloride, sodium sulfate, sodium carbonate, potassium sulfate, potassium carbonate, sodium hydrogen carbonate, potassium hydrogen carbonate, calcium chloride, magnesium chloride, and mixtures thereof.

6. The liquid washing or cleaning agent of claim 1, wherein said thickener is selected from the group consisting of xanthan, guar, carrageenan, agar agar, gellan, pectin, locust bean flour, and mixtures thereof.

7. The liquid washing or cleaning agent of claim 6, wherein said thickener is xanthan.

8. The liquid washing or cleaning agent of claim 1, further comprising a cellulase.

9. The liquid washing or cleaning agent of claim 1, further comprising an acrylic polymer.

10. Use of the washing or cleaning agent of claim 1 for the washing or cleaning of textile fabrics.

11. A method for producing a micro phase separation in a liquid washing or cleaning agent, said method comprising the step of adding from 0.05 to 1 wt % of a thickener and from 1 to 20 wt % of an inorganic salt to said liquid washing or cleaning agent.

12. The method of claim 11, wherein said liquid washing or cleaning agent comprises a graying-inhibiting polysaccharide.

13. A process for manufacturing a micro two-phase liquid washing or cleaning agent comprising: 0.1 to 60 wt % surfactant; 0.1 to 5 wt % of a graying-inhibiting polysaccharide; and, 0.05 to 1 wt % of a thickener, said method comprising the step of: adding from 1 to 20 wt % of an inorganic salt to said liquid washing or cleaning agent.
